(19) United States
(12) Patent Application Publication
(10) Pub. No.: US 2005/0280670 A1
(43) Pub. Date: Dec. 22, 2005

(54) Inkjet printhead

(75) Inventors: Sway Chuang, Pingtung (TW); Yu Jen Fang, Taichung (TW); Chin Horng Wang, Hsinchu (TW); Hsin Chien Huang, Hsinchu (TW)

Correspondence Address: BRUCE H. TROXELL;SUITE 1404, 5205 LEESBURG PIKE, FALLS CHURCH, VA, 22041, US

(73) Assignee: Industrial Technology Research Institute

(21) Appl. No.: 10/965,890

(22) Filed: Oct. 18, 2004

(30) Foreign Application Priority Data
Jun. 17, 2004 (TW) 93117417

(51) Int. Cl. B41J 2/05

(52) U.S. Cl. 347/61

(57) ABSTRACT

An inkjet print-head architecture, mainly comprises nozzle, heater plates, a chamber and an inlet hole, wherein, the nozzle is arranged inside the chamber for ejecting the ink therefrom, the heater plates are arranged in the chamber for heating the ink in the chamber to be ejected from the nozzle, and the inlet hole is also being arranged in the chamber for enabling the ink to refill the chamber directly through the same and without through a manifold. Since the design of the inlet hole of the present invention provides an one-on-one refill to the chamber thereof, the jetting frequency response of the inkjet printhead is enhanced.

### FIELD OF THE INVENTION

The present invention relates to a printhead, and more particularly, to an inkjet print head having an inlet hole directly under its chamber.

### BACKGROUND OF THE INVENTION

Generally, there are three liquid droplet injection designs capable of ejecting liquid droplet with uniform droplet size, which are thermal bubble inkjet printhead, electrostatic inkjet printhead and piezoelectric inkjet printhead. The present invention will focus on the thermal bubble inkjet printhead due to its simplicity and relatively low cost.

Refer to FIG. 1, which is a cross-sectional view of an inkjet printhead disclosed in U.S. Pat. No. 6,102,530. As seen in FIG. 1, the printhead 100 has two heater plates of different size. Since the smaller heater plate 20 will heat up quicker than the larger heater plate 22, the smaller heater plate 20 forms a sphere thermal bubble 30 while the larger heater plate 22 forms a hemisphere thermal bubble 32. As both bubbles 30, 32 expand in the direction of arrow P, the bubble 30 will restrict ink to flow from the manifold 16 to the chamber 14 and the bubble 32 will pressurize the chamber 14 causing the ink 26 to be ejected through orifice 18 as a ink column 36 in direction F.

As the bubbles 30 and 32 continue to expand and form a virtual valve, the bubble 30 and the bubble 32 approach each other and terminate ejection of ink 26 through orifice 18. As the two bubbles 30 and 32 begin to coalesce, the tail of the ink column 36 is abruptly cut off, thereby preventing the formation of satellite droplets. However, the sequential formation of the bubbles 30 and 32 will exert an uneven force on the ink in the chamber 14 and thereby push the ink to flow from the chamber 14 to the manifold 16 such that the flowing of ink in the manifold 16 is affected. The portion of ink flow from the chamber 14 to the manifold 16 that is forced by the two sequentially formed bubbles 30 and 32 will cause the ink 26 in the chamber 14 to cross talk with the ink in the other chamber such that the inkjet quality of the printhead 100 is reduced.

To solve the cross talk problem, a printhead with hemisphere chamber is provided according to prior arts. Please refer to FIG. 2, which is a cross-sectional view of a conventional printhead with hemisphere chamber. The printhead 200 is consisted of two hemisphere chambers 210 and 220 symmetrically disposed in the vicinity of a manifold 230 from which ink can be provided to the two chambers 210 and 220 through the ink channels 240.

Please refer to FIG. 3, which is a cross-sectional view showing a hemisphere chamber 210 of a conventional printhead. The hemisphere chamber 210 has a circular heater plate of the same cross-section and symmetrically disposed around the nozzle 370, as the plates 310 and 320 seen in FIG. 3. The ink 350 can be ejected while the thermal bubbles are formed under the circular plate, as the bubbles 330 and 340 seen in FIG. 3.

Since the two hemisphere chambers 210 and 220 are of the same dimension and are disposed symmetrically with respect to the manifold 230, and moreover, the heater plates inside the both chambers 210 and 220 are also symmetrically disposed around the nozzle thereof, the effect of the ink pushed by the thermal bubble generated in the chamber 210 to flow toward the manifold 230 can be neutralized by the ink pushed by the bubble generated in the chamber 220. In this regard, the problem of cross talk is solved. However, ejection frequency of the printhead 200 is not as preferable as that of the printhead 100, since the ink in the manifold 230 is required to feed the two chambers 210 and 220 separately. In addition, the thermal bubbles formed respectively in the chambers 210 and 220 are not able to cut off the ink ejection abrupt enough that satellite droplets are formed, since the thermal bubbles are symmetrical in size and shape.

Please refer to FIG. 4, which is a cross-sectional view of another conventional printhead capable of preventing the formation of satellite droplets. Instead of placing the heater plates next to the orifice or nozzle, the printhead 400 place a heater plate 410 facing toward the nozzle 490 so that the thermal bubble 420 generated by the heater plate 410 can push and eject the ink 430 out of the nozzle 490 directly for avoiding the formation of satellite droplets. However, the refill rate of the chamber 440 is still unsatisfactory that the ejection frequency of the printhead 400 is poor, since the ink 430 in the chamber 440 is still provided by the ink channel 450.

From the above description, the printhead with asymmetrically disposed heater plates will suffer the problem of cross talk. However, the printhead with symmetrical disposed chambers will have a slow injection frequency since the two symmetrical chambers use the ink provided by a same manifold. As for the printhead employing symmetrically disposed heater plates will suffer the formation of satellite droplets.

To sum up, the printhead of the invention can minimize cross talk, maintain a high frequency response, and eliminate satellite droplets while increasing the injection speed and quality.

### SUMMARY OF THE INVENTION

The primary object of the invention is to provide an inkjet printhead, mainly comprises a nozzle, a heater plate, a chamber and an inlet hole, wherein, the nozzle is arranged inside the chamber for ejecting the ink therefrom, the heater plate is arranged in the chamber for heating the ink in the chamber to be ejected from the nozzle, and the inlet hole is also being arranged in the chamber for enabling the ink to refill the chamber directly through the same and without through a manifold.

In a preferred embodiment of the invention, the heater plate is surrounded by the openings of the inlet hole. That is, the inlet hole is connected to the chamber through the two openings arranged on the chamber at two locations that are separated by the heater plate, in addition, each opening is a tube with square cross section and has an end connecting the chamber that is parallel to the heater plate.

Moreover, the side view of the inlet hole is a trapezoid that is connected to the openings by the short side of the trapezoid.

To sum up, the printhead of the invention can minimize cross talk, maintain a high frequency response, and eliminate satellite droplets while increasing the injection speed and quality.

### BRIEF DESCRIPTION OF THE DRAWINGS

FIG. 1 is a cross-sectional view of an inkjet printhead disclosed in U.S. Pat. No. 6,102,530.

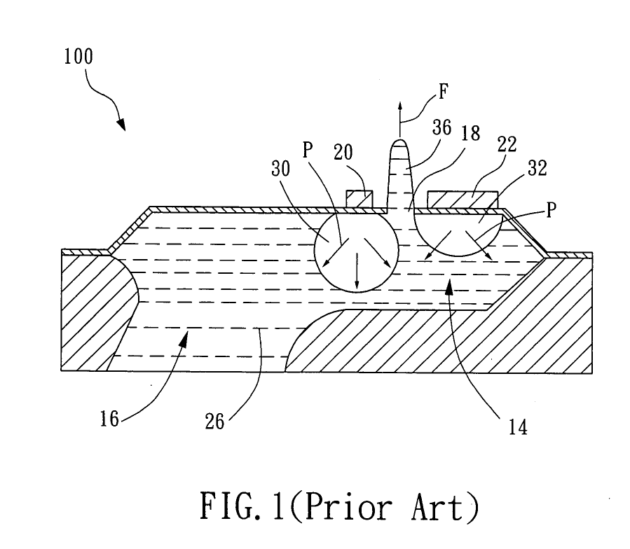

FIG. 2 is a cross-sectional view of a conventional printhead with hemisphere chamber.

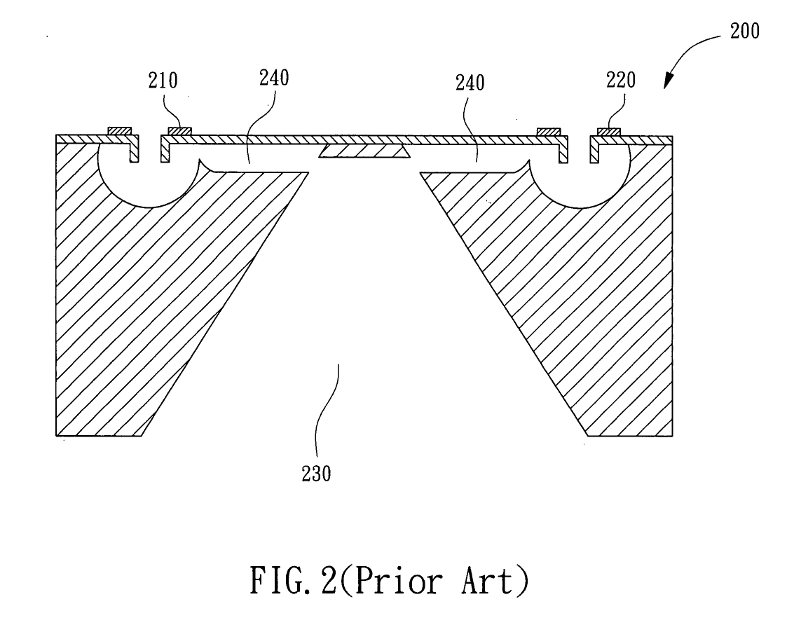

FIG. 3 is a cross-sectional view showing a hemisphere chamber of a conventional printhead.

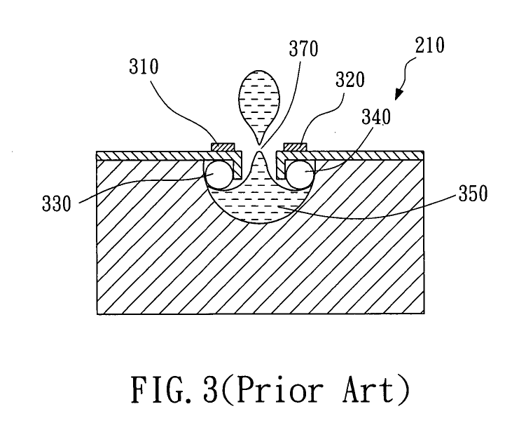

FIG. 4 is a cross-sectional view of another conventional printhead.

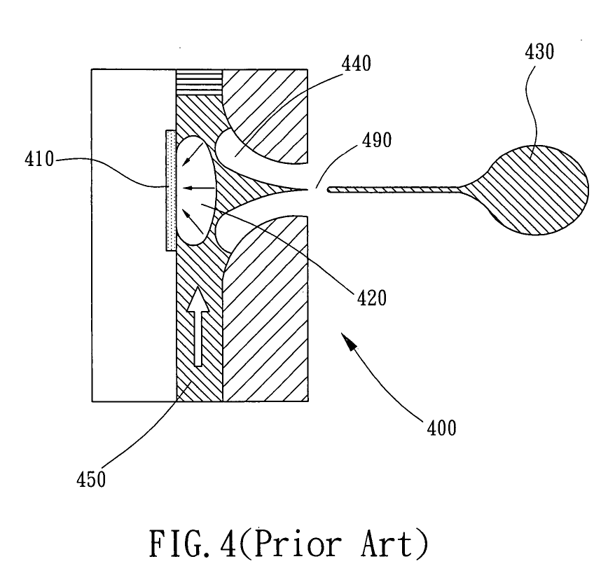

FIG. 5 is a cross-sectional view of a printhead according to a preferred embodiment of the present invention.

FIG. 6 is a top view of a printhead according to a preferred embodiment of the present invention.

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

Considering that the printhead with asymmetrically disposed heater plates will suffer the problem of cross talk, and the printhead with symmetrical disposed chambers will have a slow injection frequency since the two symmetrical chambers use the ink provided by a same manifold, and the printhead employing symmetrically disposed heater plates will suffer the formation of satellite droplets, the present invention connects the inlet hole directly to the chamber. That is, the ink can be provided to the chamber directly through the inlet hole connecting to the manifold and without going through the ink channel. In addition, the heater plate of the invention is placed facing to the nozzle.

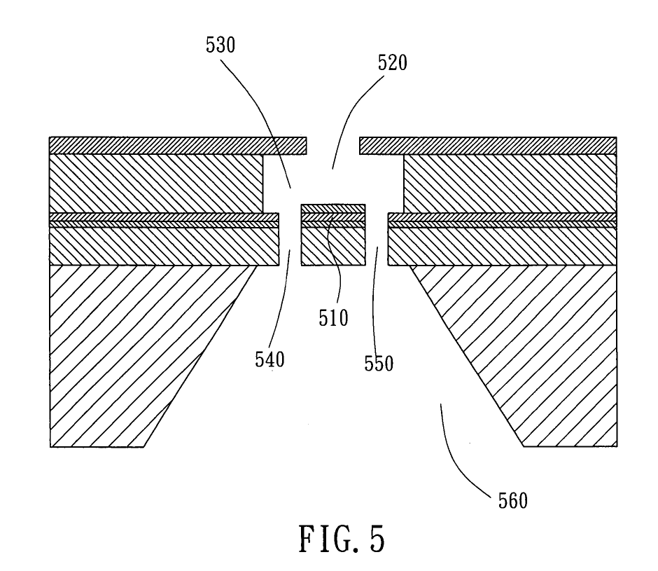

Please refer to FIG. 5, which is a cross-sectional view of a printhead according to a preferred embodiment of the present invention. The inkjet printhead 500 mainly comprises a heater plate 510, a nozzle 520, and an inlet hole 560, wherein, a chamber 560 formed by the heater plate 510 and the nozzle 520 is directly connected to the inlet hole 560 such that ink can be provided to the chamber 530 directly through the inlet hole without having to go through the ink channel of prior arts.

While the manifold (not shown) inside the printhead 500 is connected directly to the inlet hole 560 for enabling the ink to be fed into the chamber 530 directly through the inlet hole 560, the refill rate of ink is enhanced by which the ejection speed of the invention is faster than that of prior arts.

Generally, the inlet hole 560 is a layer of metal or a thick layer of photoresist, whose shape is designed according to requirement. The openings 540 and 550 of the inlet hole 560 arranged in the chamber 530 are placed surrounding the heater plate 510, and each opening has an end connecting the chamber that is parallel to the heater plate 510.

In a preferred embodiment of the invention, the side view of the inlet hole 560 is a trapezoid that is connected to the chamber 530 by the short side of the trapezoid. The inlet hole 560 is connected to the chamber 530 through the two openings 540, 550 arranged on the chamber, by which ink can be fed into the chamber 530 therefrom. Since the diameter of the inlet hole 560 connecting the chamber 530 is smaller then that of the inlet hole 560 connecting the manifold, the ink can be block from flowing back to the manifold from the chamber 530 while feeding the ink into the chamber 530 through the inlet hole 560, such that the cross talk between chamber 530 with other chambers in the printhead 500 is solved.

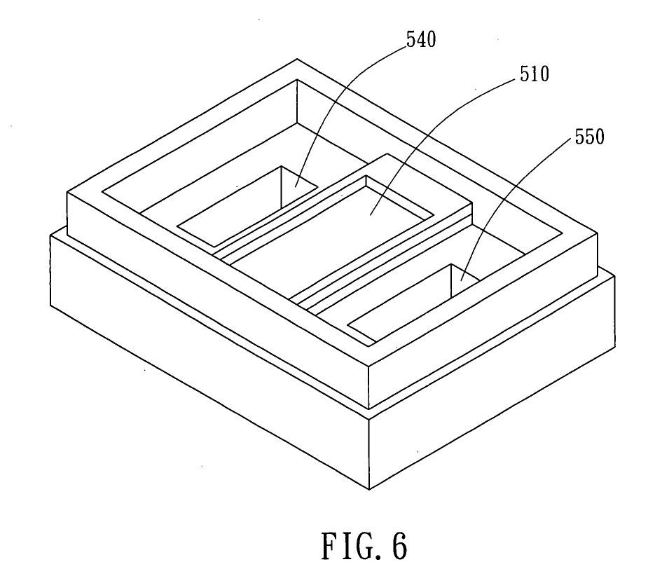

Please refer to FIG. 6, which is a top view of a printhead according to a preferred embodiment of the present invention. The two openings 540, 550 arranged respectively at the two side of the heater plate 510 are tubes with square cross section as seen in FIG. 6. In a preferred embodiment of the invention, the opening can be of other shapes without limiting to be a tube with square cross section. For example, it can be a tube with circular cross section.

The heater plate 510 in the chamber 530 is placed facing to the nozzle 520 for enabling the thermal bubble generated by the heater plate 510 to push and eject the ink out of the nozzle 520 directly so as to avoid the formation of satellite droplets.

To sum up, the printhead of the invention has a chamber therein connected directly to a inlet hole for providing an one-on-one refill to the chamber thereof. Since the ink can be fed into the chamber without going through an ink channel, the jetting frequency response of the inkjet printhead is enhanced, i.e. about 50 KHz. In addition, the inlet hole with trapezoid side view is capable of minimizing cross talk. In this regard, the printhead of the invention having the advantages as disclosed above can also be used in a multitude of other potential applications, such as high-resolution, high-speed liquid injector, micro-fluids technology, micro-droplet generator, direct print lithography, to name as few.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

1. An inkjet printhead, comprising:
a chamber,
a nozzle, arranged inside a chamber for ejecting an ink therefrom;
a heater plate, arranged in the chamber for heating the ink in the chamber to be ejected from the nozzle; and
at least an inlet hole, having at least an opening arranged in the chamber, for enabling the ink to refill the chamber directly through the same.

2. The printhead of claim 1, wherein the printhead has two inlet holes.

3. The printhead of claim 2, wherein each opening of the two inlet holes is arranged at a side of the heater plate.

4. The printhead of claim 1, wherein the heater plate is surrounded by the plural openings of the inlet hole.

5. The printhead of claim 1, wherein each opening is parallel to a heating surface of the heater plate.

6. The printhead of claim 1, wherein the shape of the opening is selected at will.

7. The printhead of claim 1, wherein the arrangement of the plural openings in the chamber is selected at will.

8. The printhead of claim 1, wherein the inlet hole is a layer of metal.

9. The printhead of claim 1, wherein the inlet hole is a thick layer of photoresist.

10. The printhead of claim 1, wherein the inlet hole is connected to a manifold.

11. The printhead of claim 1, wherein the side view of the inlet hole is a trapezoid having the short side thereof connected to the chamber.

12. The printhead of claim 1, wherein the heater plate has a heating surface facing toward the nozzle.
